(19) United States
(12) Patent Application Publication
(10) Pub. No.: US 2014/0329211 A1
(43) Pub. Date: Nov. 6, 2014

(54) PROVIDING LOCATION-RELEVANT GOAL FULFILLMENT RECOMMENDATIONS WHILE INSIDE A NON-RESIDENTIAL LOCATION

(71) Applicants: LEE A. CARBONELL, FLOWER MOUND, TX (US); TSZ S. CHENG, GRAND PRAIRIE, TX (US); JEFFREY L. EDGINGTON, KELLER, TX (US); PANDIAN MARIADOSS, ALLEN, TX (US)

(72) Inventors: LEE A. CARBONELL, FLOWER MOUND, TX (US); TSZ S. CHENG, GRAND PRAIRIE, TX (US); JEFFREY L. EDGINGTON, KELLER, TX (US); PANDIAN MARIADOSS, ALLEN, TX (US)

(73) Assignee: INTERNATIONAL BUSINESS MACHINES CORPORATION, ARMONK, NY (US)

(21) Appl. No.: 13/874,569

(22) Filed: May 1, 2013

(51) Int. Cl. G09B 5/08

(52) U.S. Cl. CPC G09B 5/08
USPC 434/236

(57) ABSTRACT

A method for providing location-relevant goal fulfillment messages to a mobile device can begin with a location-based goal coaching system receiving location data for a mobile device. When inside a non-residential location, a proximate area map for the mobile device can be dynamically generated using the received location data. The proximate area map can express a position of the mobile device within the non-residential location and points of interest or items within a predefined radius of the mobile device. Elements of the proximate area map that are relevant to a goal expressed in a previously defined user-specific goal profile can be identified. For each goal having a relevant identified element, a goal fulfillment recommendation can be created. The goal fulfillment recommendation can then be conveyed to the mobile device, making the user aware of the nearby presence of the item or point of interest and its relationship to the goal.

### BACKGROUND

The present invention relates to the field of goal fulfillment and, more particularly, to providing location-relevant goal fulfillment recommendations while inside a non-residential location.

Setting goals and performing related tasks to achieve those goals is a common activity is many people's lives. Various tools exist to help people define and track their goals; however, these tools often rely upon the user to recognize elements of their surroundings that support their goals and to enter data into the tool on a regular basis. Thus, these tools are only as effective as the user's commitment to provide data in a timely manner and the user's capability to understand the relationship between elements in their surroundings to achieving their goals.

Location-aware services are commonplace on many mobile devices to provide a user with information near their current location that match specific criteria. A common example is a smartphone weather service that provides the user with the weather forecast for their current location. While such services are helpful, they are only useful when the user is out-of-doors because the service functions using basic geographical and/or categorical information like a phone book. Once the user enters a building, particularly a non-residential location like a store or museum, these services are unable to provide any further information or suggestions.

While many non-residential locations have online information available, the user must seek out the information and analyze it in order to determine what the non-residential location offers that will help them obtain their individual goals. As with all human-based processes, the effectiveness of this process lies with the user and their abilities. Thus, the user will most likely miss out on nearby opportunities that would help them achieve their individual goals.

### BRIEF SUMMARY

One aspect of the present invention can include a method for providing location-relevant goal fulfillment messages to a mobile device. Such a method can begin with a location-based goal coaching system receiving location data for a mobile device. When inside a non-residential location, a proximate area map for the mobile device can be dynamically generated using the received location data. The proximate area map can express a position of the mobile device within the non-residential location and points of interest or items within a predefined radius of the position of the mobile device. Elements of the proximate area map that are relevant to a goal expressed in a user-specific goal profile for a user of the mobile device can be identified. The user-specific goal profile can have been previously defined within the location-based goal coaching system by the user. For each goal of the user-specific goal profile having a relevant identified element, a goal fulfillment recommendation can be created for that goal. The goal fulfillment recommendation can be an electronic message indicating a nearby presence of an item or point of interest that is related to a goal. The goal fulfillment recommendation can then be conveyed to the mobile device, making the user aware of the nearby presence of the item or point of interest and its relationship to the goal.

Another aspect of the present invention can include a system for providing location-relevant goal fulfillment messages. Such a system can be comprised of a network-enabled mobile device, a user-specific goal profile, and a location-based goal coaching system. The user-specific goal profile can define goals and supporting data for the goals. The location-based goal coaching system can be configured to provide goal fulfillment recommendations to the network-enabled mobile device based upon location data for the mobile device when inside a non-residential location and the user-specific goal profile associated with a user of the network-enabled mobile device. The goal fulfillment recommendation can be an electronic message indicating a nearby presence of an item or point of interest that is related to a goal contained within the user-specific goal profile.

Yet another aspect of the present invention can include a computer program product that includes a computer readable storage medium having embedded computer usable program code. The computer usable program code can be configured to receive location data for a mobile device. The computer usable program code can be configured to, when inside a non-residential location, dynamically generate a proximate area map for the mobile device using the received location data. The proximate area map can express a position of the mobile device within the non-residential location and points of interest or items within a predefined radius of the position of the mobile device. The computer usable program code can be configured to identify elements of the proximate area map that are relevant to a goal expressed in a user-specific goal profile for a user of the mobile device. The user-specific goal profile can have been previously defined within the location-based goal coaching system by the user. The computer usable program code can then be configured to, for each goal of the user-specific goal profile having a relevant identified element, create a goal fulfillment recommendation for that goal. The goal fulfillment recommendation can be an electronic message indicating a nearby presence of an item or point of interest that is related to a goal. The computer usable program code can be configured to convey the goal fulfillment recommendation to the mobile device, making the user aware of the nearby presence of the item or point of interest and its relationship to the goal.

### BRIEF DESCRIPTION OF THE SEVERAL VIEWS OF THE DRAWINGS

FIG. 1 is a flowchart of a method describing a user's perspective for interacting with a location-based goal coaching system in accordance with embodiments of the inventive arrangements disclosed herein.

FIG. 2 is a schematic diagram illustrating a system supporting operation of a location-based goal coaching system that provides goal fulfillment recommendations in accordance with an embodiment of the inventive arrangements disclosed herein.

FIG. 3 is a flowchart of a method describing an example of the operation of the location-based goal coaching system in accordance with an embodiment of the inventive arrangements disclosed herein.

FIG. 4 is an illustration depicting the relationship between goal profile data, the proximate area map, and goal fulfillment recommendations in accordance with embodiments of the inventive arrangements disclosed herein.

### DETAILED DESCRIPTION

The present invention discloses a solution for location-relevant goal fulfillment recommendations. A user can define a goal profile with a location-based goal coaching system. When the user enters a non-residential location during the course of their daily life, the location-based goal coaching system can receive location data from the user's mobile device. Based on this location data, the location-based goal coaching system can generate a proximate area map for the non-residential location and identify nearby items or points of interest that are relevant to goals defined in the user's goal profile. Goal fulfillment recommendations can be created and sent to the user's mobile device for nearby items or points of interest that are determined to be relevant to one of the user's goals.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

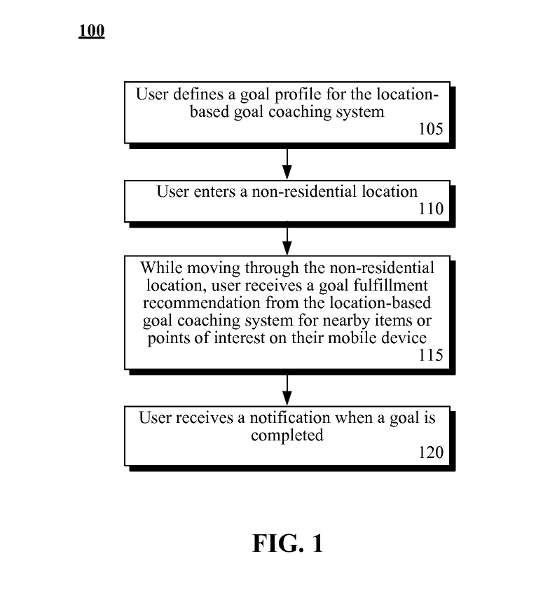

FIG. 1 is a flowchart of a method 100 describing a user's perspective for interacting with a location-based goal coaching system in accordance with embodiments of the inventive arrangements disclosed herein. Method 100 can begin in step 105 where the user can define a goal profile for the location-based goal coaching system. Step 105 can assume that the user has already registered with the location-based goal coaching system (i.e., created a username and password, submitted a valid email address, etc.) or step 105 can be a part of the registration process.

The user can enter a non-residential location in step 210. As used herein, the term “non-residential location” can refer to a physical building or structure that is not used as permanent residence for a person. Examples of non-residential locations can include, but are not limited to, a retail store, a grocery store, a mall, a restaurant, a conference center, a museum, a hotel (many hotels have large meeting spaces that are frequently used for hosting exhibitors associated with a meeting or conference), a sports venue, and the like.

In step 115, the user can receive a goal fulfillment recommendation from the location-based goal coaching system as they move through the non-residential location. The goal fulfillment recommendation can be an electronic message sent to the user's mobile device that makes the user aware of nearby items or points of interests that will help the user fulfill a goal from their goal profile. When a goal in the goal profile is completed, the user can receive a notification indicating the completion in step 120.

It is important to emphasize how the user interaction of method 100 differs from conventional goal tracking systems and location-aware services. A conventional goal tracking system can often be a simple electronic and/or online means for the user to manually enter their goals and related data. For example, many fitness-related goal tracking systems, such as MyFitnessPal, can require the user to input their current weight, what they eat, and the exercises they perform every day.

These systems can only analyze the manually entered data and cannot provide the user with proactive information to help them achieve their goals. The location-based goal coaching system, however, can make the user aware of nearby items or points of interest related to their goal, helping the user to be proactive in their goal achievement.

Location-aware services can be a common tool used by many mobile device users. Typically, a location-aware service can provide a user with a listing of a specified type of a point of interest nearby or within a specific radius of their current location. Conventional location-aware services can lack the ability to relate their information to the user's goals.

Further, conventional location-aware services can be limited to outdoor geographic information. That is, a conventional location-aware service can tell the user what stores are in the area, but cannot provide any additional information once inside a store. The location-based goal coaching system can be specifically designed to tell the user, after they enter the store, what areas or items of the store will help them achieve their goals.

Store-specific mobile device applications can be available for many stores as well as other large or public non-residential locations like museums and sports venues. Such applications can simply provide the user with a map or layout of the location without any relationship to the user's individual goals. Some applications like Aisle411 can tell the user what aisle of a store where they can find a product. Again, such an application requires manual entry by the user and lacks any ability for helping the user achieve a goal.

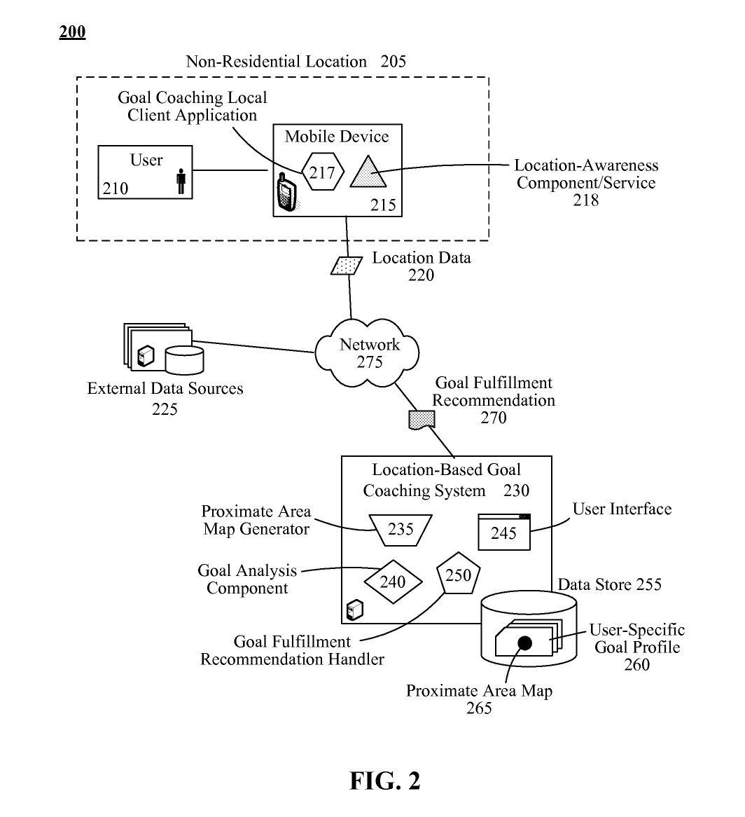

FIG. 2 is a schematic diagram illustrating a system 200 supporting operation of a location-based goal coaching system 220 that provides goal fulfillment recommendations 270 in accordance with embodiments of the inventive arrangements disclosed herein. System 200 can be utilized to perform the steps of method 100.

In system 200, a user 210 can enter a non-residential location 205 with a mobile device 215. As previously discussed, the non-residential location 205 can be one of a variety of structures that are not commonly used as a permanent residence. The mobile device 215 can represent a variety of electronic devices capable of communicating with location-based goal coaching system 220 over a network 275.

The mobile device 215 can also be capable of supporting operation of the goal coaching local client application 217, herein referred to as the client application 217, and can include a location-awareness component and/or services 218. The client application 217 can be a software program installed upon the mobile device 215 that performs operations local to the mobile device 215 for the location-based goal coaching system 220. For example, the client application 217 can be configured to collect location data 220 from the location-awareness component/services 218 and convey the location data 220 to the location-based goal coaching system 220. The client application 217 can also be responsible for presenting goal fulfillment recommendations 270 on the mobile device 215.

The location-awareness component/services 218 can be the hardware and/or software elements that can determine a location of the mobile device 215. The exact composition of the location-awareness component/services 218 can vary based upon the type of mobile device 215. For example, the location-awareness component/services 218 can encompass a GPS transceiver and the software that translates the GPS signal into coordinates. Alternately, the location-awareness component/services 218 can be a cloud or Web service (not shown) that translates positional information like GPS coordinates into a street address.

The location-awareness component/services 218 can provide the client application 217 with location data 220. The contents of the location data 220 can vary based upon the type of location-awareness component/services 218. For example, when the location-awareness component/services 218 is a wireless network transceiver of the mobile device 215, the location data 220 can be an identifier of the local or ad hoc network 275 that the mobile device 215 is using to communicate with the location-based goal coaching system 220.

The location-based goal coaching system 220 can represent the hardware and/or software components required to provide the user 210 with goal fulfillment recommendations 270 based upon the location data 220 of the mobile device 215. The location-based goal coaching system 220 can include a proximate area map generator 235, a goal analysis component 240, a user interface 245, a goal fulfillment recommendation handler 250, and a data store 255 for storing user-specific goal profiles 260.

When the user 210 registers to use the location-based goal coaching system 220, the user 210 can be required to fill-out a user-specific goal profile 260, herein referred to as the goal profile 260, using the user interface 245. The user interface 260 can be a graphical interaction mechanism for data collection from the user 210. The user interface 245 can be configured such that it is accessible from the mobile device 215 as part of the client application 217 and/or a non-mobile computing device like a desktop computer.

The goal profile 260 can be a collection of data about the user 210 and their goals. The user interface 245 can be configured to provide a specific format that the user 210 follows to define goals and related data for the goal profile 260. This format can be dependent upon the specific implementation of the location-based goal coaching system 220. As an example, the goal profile 260 can adhere to the S.M.A.R.T. approach for goal setting, requiring that the goal be Specific, Measurable, Achievable, Relevant, and Time-based. Additionally, the goal profile 260 can include information about how the user 210 prefers to be notified, the format and/or frequency of the goal fulfillment recommendations 270, the distance away the target of the goal fulfillment recommendation 270 should be, and so on.

When the location-based goal coaching system 220 receives the location data 220 for the mobile device 215, a proximate area map 265 can be created for the user 210 and stored with their goal profile 260. The proximate area map 265 can be a translation of the location data 220 into a map of the non-residential location 205. Creation of the proximate area map 265 by the proximate area map generator 235 can vary based on the type of location data 220 received and can require obtaining additional information from one or more external data sources 225.

An external data source 225 can represent a service or repository from which the location-based goal coaching system 220 can access information pertinent to the non-residential location 205, goal profile 260, and/or other related items. For example, since the user 210 is inside the non-residential location 205, the proximate area map generator 235 can identify the non-residential location 205 using a mapping service 225 and then retrieve a layout for that non-residential location 205 from the appropriate Web site 225.

In essence, the proximate area map 265 can be thought of as a placement of the user 210 within the general layout of the non-residential location 205. The proximate area map 265 can also include additional information dependent upon the type of non-residential location 205, such as product groupings or departments for retail stores or seminar times and locations for the rooms of a conference center.

The goal analysis component 240 can represent the software data analysis tools used to analyze and determine relationships between the proximate area map 265 and the goal profile 260. When an element of the proximate area map 265 is determined to be relevant to a goal of the goal profile 260, the goal analysis component 240 can pass the information to the goal fulfillment recommendation handler 250. The goal fulfillment recommendation handler 250 can then create and send a goal fulfillment recommendation 270 to the mobile device 215.

The goal fulfillment recommendation 270 can be an electronic message whose contents make the user 210 aware of the nearby item or point of interest and the related goal. The format of the goal fulfillment recommendation 270 can vary based upon the specific implementation of the location-based goal coaching system 220, the preferences of the user 210, and/or the receiving mobile device 215.

In its simplest form, the location-based goal coaching system 220 can simply provide goal fulfillment recommendations 270 to help the user 210 make better choices to achieve their goals. In more robust embodiments, the location-based goal coaching system 220 can be combined with additional components to expand its functionality for more specific contexts like price or product comparisons.

In another contemplated embodiment, the location-based goal coaching system 220 can be integrated with a conventional goal tracking system.

As used herein, presented data store 255 and external data sources 225 can be a physical or virtual storage space configured to store digital information. Data store 255 and external data sources 225 can be physically implemented within any type of hardware including, but not limited to, a magnetic disk, an optical disk, a semiconductor memory, a digitally encoded plastic memory, a holographic memory, or any other recording medium. Data store 255 and external data sources 225 can be a stand-alone storage unit as well as a storage unit formed from a plurality of physical devices. Additionally, information can be stored within data store 255 and external data sources 225 in a variety of manners. For example, information can be stored within a database structure or can be stored within one or more files of a file storage system, where each file may or may not be indexed for information searching purposes. Further, data store 255 and/or external data sources 225 can utilize one or more encryption mechanisms to protect stored information from unauthorized access.

Network 275 can include any hardware/software/and firmware necessary to convey data encoded within carrier waves. Data can be contained within analog or digital signals and conveyed though data or voice channels. Network 275 can include local components and data pathways necessary for communications to be exchanged among computing device components and between integrated device components and peripheral devices. Network 275 can also include network equipment, such as routers, data lines, hubs, and intermediary servers which together form a data network, such as the Internet. Network 275 can also include circuit-based communication components and mobile communication components, such as telephony switches, modems, cellular communication towers, and the like. Network 275 can include line based and/or wireless communication pathways.

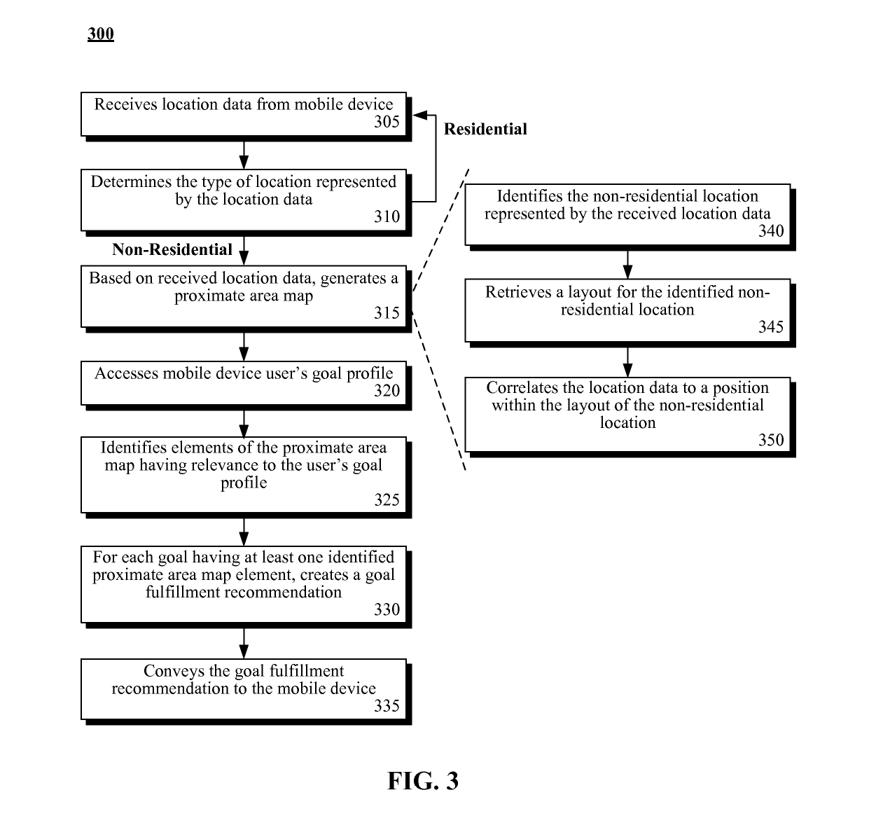

FIG. 3 is a flowchart of a method 300 describing an example of the operation of the location-based goal coaching system in accordance with embodiments of the inventive arrangements disclosed herein. Method 300 can be performed within the context of method 100 and/or system 200.

Method 300 can begin in step 305 where the location-based goal coaching system can receive location data from the mobile device. The type of location represented by the location data can be determined in step 310. When the location data represents a residential structure, flow of method 300 can return to step 305.

When the location data corresponds to a non-residential location, step 315 can be performed where a proximate area map can be generated based upon the received location data. The execution of step 315 can include the performance of substep 340 where the non-residential location represented by the received location data can be identified. A layout for the identified non-residential location can then be retrieved from the appropriate data source in substep 345. In substep 350, the location data can be correlated to a position within the layout of the non-residential location.

Once the proximate area map has been generated, the user's goal profile can be accessed in step 320. In step 325, elements of the proximate area map having relevance to the user's goal profile can be identified.

For each goal having at least one identified element of the proximate area map, a goal fulfillment recommendation can be created in step 330. In step 335, the goal fulfillment recommendation can be conveyed to the mobile device.

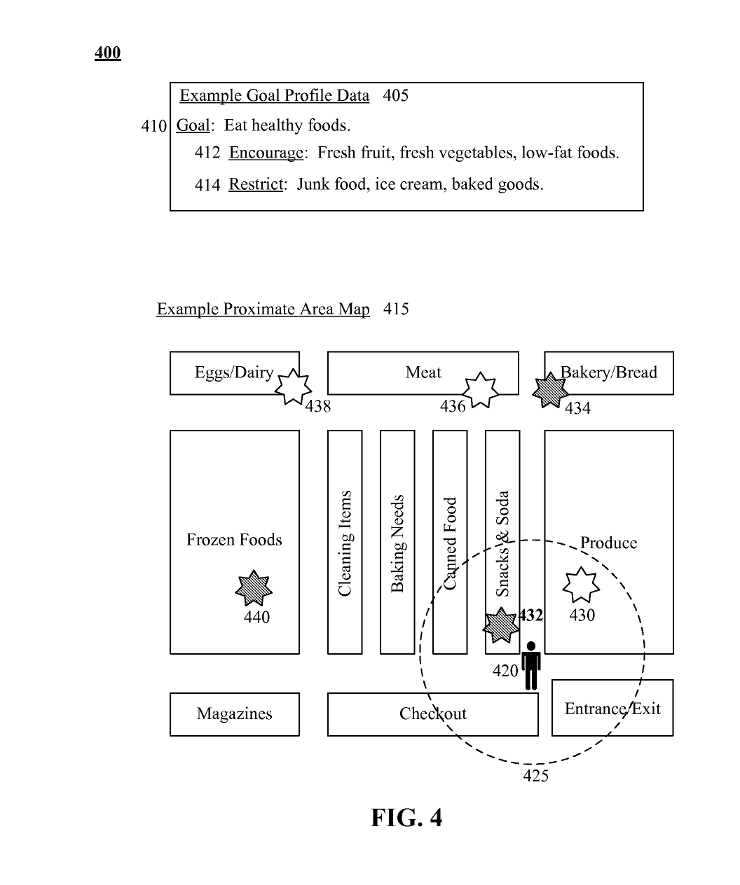

FIG. 4 is an illustration 400 depicting the relationship between goal profile data 405, the proximate area map 415, and goal fulfillment recommendations 430-440 in accordance with embodiments of the inventive arrangements disclosed herein. The example of illustration 400 can be utilized within the context of system 200 and/or methods 100 and/or 300.

Illustration 400 can provide a simple example of goal profile data 405. The example goal profile data 405 can be comprised of a goal 410, items or behaviors to encourage 412, and items or behaviors to restrict 414. As previously discussed, the goal 410 and its related data 412 and 414 can adhere to a predefined format that is interpretable by the location-based goal coaching system.

In this example, the goal 410 can be to eat healthy foods. For this goal 410, the user 420 can desire to encourage 412 the purchase and/or consumption of fresh fruit, fresh vegetables, and low-fat foods, while restricting 414 junk food, ice cream, and baked goods. The location-based goal coaching system can be configured to judge subjective terminology, if used, based upon generally accepted guidelines like a specified diet or an authoritative entity. Further, the used of additional data fields like the encouragements 412 and restrictions 414 can also be used when handling subjective terms.

The example proximate area map 415 can show the user's 420 position upon entering a typical grocery store. From the store layout, the location-based goal coaching system can identify the basic types of food items carried by the store and can determine the areas of the store layout related to the user's 420 goal 410 and the foods they want to encourage 412 and restrict 414. In this example, these areas can be marked with a star to indicate the generation of a goal fulfillment recommendation 430-440.

Depending upon implementation, the location-based goal coaching system can process the entirety of the non-residential location's layout or can process the section of the layout within the predefined radius 425 of the user 420. That is, the entire layout can be processed, goal fulfillment recommendations can be created but not conveyed to the user 420 until the area is within the predefined radius 425; or, only the area of the layout within the predefined radius 425 can be processed and any triggered goal fulfillment recommendations can be created and sent to the user 420.

For illustrative purposes, all the areas of the store that would generate a goal fulfillment recommendation 430-440 for the example goal profile data 405 have been marked on the proximate area map 415. At their current position, the user 420 would receive two messages—goal fulfillment recommendation 430 encouraging fresh fruits and vegetables and goal fulfillment recommendation 432 discouraging junk food. Further, the goal fulfillment recommendations 432, 434, and 440 corresponding to goal 410 restrictions 414 can be indicated in grey to provide a visual distinction in this example.

As the user 420 moves through the store, the other indicated goal fulfillment recommendations 434-440 can be provided to the user 420 once within the predefined radius 425. It is important to emphasis that the only active part of the user 420 can be to enter the goal profile data 405. The goal fulfillment recommendations 430-440 can be automatically provided to the user 420 regardless of the store or restaurant.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for providing location-relevant goal fulfillment messages comprising:
receiving of location data for a mobile device by a location-based goal coaching system;
when inside a non-residential location, dynamically generating a proximate area map for the mobile device using the received location data, wherein said proximate area map expresses at least a position of the mobile device within the non-residential location and points of interest or items within a predefined radius of the position of the mobile device;
identifying at least one element of the proximate area map that is relevant to a goal expressed in a user-specific goal profile for a user of the mobile device, wherein the user-specific goal profile was previously defined within the location-based goal coaching system by the user;
for each goal of the user-specific goal profile having at least one relevant identified element, creating a goal fulfillment recommendation for that goal, wherein the goal fulfillment recommendation is an electronic message indicating a nearby presence of an item or point of interest that is related to a goal; and
conveying the goal fulfillment recommendation to the mobile device, wherein the user is made aware of the nearby presence of the item or point of interest and its relationship to the goal.

2. The method of claim 1, wherein generating the proximate area map further comprises:
identifying the non-residential location represented by the received location data;
retrieving a layout for the identified non-residential location; and
correlating the location data to a position within the layout of the non-residential location.

3. The method of claim 1, wherein identifying at least one element of the proximate area map further comprises:
accessing the user-specific goal profile of the user;
parsing textual identifiers contained in the proximate area map; and
determining relationships between the textual identifiers and goal data contained in the user-specific goal profile, wherein an existence of a relationship indicates relevance.

4. The method of claim 3, wherein the determining of relationships further comprises:
retrieving auxiliary data for at least one of the identified non-residential location and items or persons associated with the identified non-residential location from at least one external data source; and
utilizing said the retrieved auxiliary data for relationship determination.

5. The method of claim 1, further comprising:
receiving a plurality of goal data from the user of the mobile device; and
storing said plurality of goal data as the user-specific goal profile in a data store accessible by the location-based goal coaching system.

6. The method of claim 1, further comprising:
determining a completion of the goal;
changing a state of the goal from an active state to a completed state;
creating a goal completion message; and
conveying the goal completion message to the mobile device.

7. The method of claim 1, wherein the conveying of the goal fulfillment recommendation is postponed until the mobile device is a predetermined distance from the identified element.

8. The method of claim 1, wherein the creation of the goal fulfillment recommendation is postponed until the mobile device is a predetermined distance from the identified element.

9. A system for providing location-relevant goal fulfillment messages comprising:
a network-enabled mobile device;
a user-specific goal profile defining at least one goal and supporting data for the at least one goal; and
a location-based goal coaching system configured to provide goal fulfillment recommendations to the network-enabled mobile device based upon location data of said mobile device when inside a non-residential location and the user-specific goal profile associated with a user of the network-enabled mobile device, wherein the goal fulfillment recommendation is an electronic message indicating a nearby presence of an item or point of interest that is related to a goal contained within the user-specific goal profile.

10. The system of claim 9, wherein further comprises:
a user interface configured to be an input mechanism for capturing data that defines the user-specific goal profile.

11. The system of claim 9, wherein the location-based goal coaching system further comprises:
a proximate area map generator configured to create a proximate area map that indicates at least a position of the network-enabled mobile device within the non-residential location and points of interest or items within a predefined radius of the position of the network-enabled mobile device;
a goal analysis component configured to analyze the proximate area map with respect to the user-specific goal profile to determine a relevance of the points of interest or items indicated on the proximate area map to at least one goal of the user-specific goal profile; and
a goal fulfillment recommendation handler configured to generate the goal fulfillment recommendation for points of interest or items determined to be relevant by the goal analysis component.

12. The system of claim 9, wherein the location data comprises at least one of GPS data, cell tower triangulation data, ad hoc network identification data, network node data, and an Internet protocol (IP) address.

13. The system of claim 9, further comprising:
at least one external data source configured to provide information for at least one of the non-residential location and items or persons associated with the non-residential location.

14. The system of claim 13, wherein an external data source is one of a cloud service, a Web service, a Web site, and an online database.

15. A computer program product comprising a computer readable storage medium having computer usable program code embodied therewith, the computer usable program code comprising:
computer usable program code configured to receive location data for a mobile device;
computer usable program code configured to, when inside a non-residential location, dynamically generate a proximate area map for the mobile device using the received location data, wherein said proximate area map expresses at least a position of the mobile device within the non-residential location and points of interest or items within a predefined radius of the position of the mobile device;
computer usable program code configured to identify at least one element of the proximate area map that is relevant to a goal expressed in a user-specific goal profile for a user of the mobile device, wherein the user-specific goal profile was previously defined within the location-based goal coaching system by the user;
computer usable program code configured to, for each goal of the user-specific goal profile having at least one relevant identified element, create a goal fulfillment recommendation for that goal, wherein the goal fulfillment recommendation is an electronic message indicating a nearby presence of an item or point of interest that is related to a goal; and
computer usable program code configured to convey the goal fulfillment recommendation to the mobile device, wherein the user is made aware of the nearby presence of the item or point of interest and its relationship to the goal.

16. The computer program product of claim 15, wherein generating the proximate area map further comprises:
computer usable program code configured to identify the non-residential location represented by the received location data;
computer usable program code configured to retrieve a layout for the identified non-residential location; and
computer usable program code configured to correlate the location data to a position within the layout of the non-residential location.

17. The computer program product of claim 15, wherein identifying at least one element of the proximate area map further comprises:
computer usable program code configured to access the user-specific goal profile of the user;
computer usable program code configured to parse textual identifiers contained in the proximate area map; and
computer usable program code configured to determine relationships between the textual identifiers and goal data contained in the user-specific goal profile, wherein an existence of a relationship indicates relevance.

18. The computer program product of claim 17, wherein the determining of relationships further comprises:
computer usable program code configured to retrieve auxiliary data for at least one of the identified non-residential location and items or persons associated with the identified non-residential location from at least one external data source; and
computer usable program code configured to utilize said the retrieved auxiliary data for relationship determination.

19. The computer program product of claim 15, further comprising:
computer usable program code configured to receive a plurality of goal data from the user of the mobile device; and
computer usable program code configured to store said plurality of goal data as the user-specific goal profile in a data store accessible by the location-based goal coaching system.

20. The computer program product of claim 15, further comprising:
computer usable program code configured to determine a completion of the goal;
computer usable program code configured to change a state of the goal from an active state to a completed state;
computer usable program code configured to create a goal completion message; and
computer usable program code configured to convey the goal completion message to the mobile device.
